(19) United States
(12) Patent Application Publication
(10) Pub. No.: US 2007/0202326 A1
(43) Pub. Date: Aug. 30, 2007

(54) Fiber reinforced foam structure

(76) Inventors: Paul A. Geel, Heveadrop (NL); Tom Wassenberg, Soegel (DE); Michael P. Kuhn, Weinheim (DE); Rene H. J. Kosse, Veenhuizerweg (NL)

Correspondence Address: OWENS CORNING, 2790 COLUMBUS ROAD, GRANVILLE, OH, 43023, US

(21) Appl. No.: 11/707,372

(22) Filed: Feb. 16, 2007

Related U.S. Application Data
(60) Provisional application No. 60/775,499, filed on Feb. 22, 2006.

(51) Int. Cl. D02G 3/00; B32B 17/06; C03C 25/24

(52) U.S. Cl. 428/361; 65/447; 65/450; 428/426

(57) ABSTRACT

A precursor of a fiber reinforced foam structure includes a base veil having between about 50 and about 75 weight percent reinforcement fibers and between about 50 and about 25 weight percent veil binder. The base veil has a weight per unit area of between about 35 and about 400 g/m². Further the base veil is impregnated with an expandable binder in an amount of between about 20 to about 200 g/m².

### TECHNICAL FIELD AND INDUSTRIAL APPLICABILITY OF THE INVENTION

The present invention relates generally to the field of foam structures and more particularly to a conformable fiber reinforced foam structure, a precursor of that foam structure and method for making the same.

### BACKGROUND OF THE INVENTION

Foam structures useful as, for example, head liners, insulation parts and underbody protection parts for the automotive industry must meet a number of performance criteria. For example, such structures must deliver desirable acoustical properties to provide sound damping. They must also exhibit dimensional stability, stiffness and strength over a wide temperature range. Fire retardance is also a desirable characteristic. Significantly, all of these properties must be provided in a relatively low weight material so as to not adversely affect the fuel economy of the vehicle or raise the center of gravity of the vehicle in any way to adversely affect performance. The present invention relates to a conformable fiber reinforced foam structure meeting or exceeding desirable performance characteristics for vehicular applications.

### SUMMARY OF THE INVENTION

A precursor of a fiber reinforced foam structure is provided. The precursor includes a base veil having between about 50 and about 75 weight percent reinforcement fibers and between about 50 and about 25 weight percent veil binder. The base veil has a weight per unit area of between about 35 and about 400 g/m². Further the base veil is impregnated with an expandable binder in an amount of between about 20 to about 200 g/m². The reinforcement fibers may be selected from a group consisting of fiberglass fibers, aramid fibers, carbon fibers, polyester fibers, polyamide fibers, ceramic fibers and mixtures thereof. The reinforcement fibers are chopped at a length of between about 6.0 and about 38.0 mm and have a diameter of between about 6.5 and about 23.0 microns. The reinforcement fibers may consist of a mix of fine and course fibers.

The veil binder is a thermoplastic binder. The veil binder may be selected from a group consisting of polyolefin, polyester, polyethylene, polypropylene, polyethylene terephthalate, polyamide, copolyester and mixtures thereof. The veil binder may comprise fibers having a length of between about 0.5 to about 15.0 mm and a denier of between about 1 to about 5. The veil binder fibers may include bicomponent fibers. In addition or in the alternative, the veil binder may comprise a powder having particles of between 10 to about 50 microns.

The expandable binder comprises expandable microspheres and an emulsion or solution binder. The emulsion or solution binder is selected from a group consisting of ethylene vinyl acetate, polyvinyl alcohol, polyurethane, styrene butadiene rubber, cellulose, starch, urea formaldehyde, melamine formaldehyde, acrylic, fluorocarbon and mixtures thereof. The expandable microspheres comprise a thermoplastic resin material incorporating a blowing agent. In all, the precursor has a weight per unit area of between about 100 to about 200 g/m².

In accordance with an additional aspect of the present invention, the present invention relates to a fiber reinforced foam structure molded or otherwise made from the precursor.

In accordance with still another aspect of the present invention, a method is provided for preparing both a precursor and a reinforced fiber structure. That method comprises forming a base veil including between about 50 and about 75 weight percent reinforcement fibers and about 50 and about 25 weight percent veil binder wherein the base veil has a weight per unit area of between about 35 and about 400 g/m². In addition the method includes the steps of impregnating the base veil with an expandable binder in an amount of between about 20 to about 200 g/m² to produce the precursor. Further the method includes molding the impregnated base veil or precursor so as to activate the expandable binder and create the fiber reinforced foam structure.

In the following description there is shown and described a preferred embodiment of this invention simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawing incorporated in and forming a part of this specification, illustrates several aspects of the present invention, and together with the description serves to explain certain principles of the invention. In the drawing:

FIG. 1 is an edge on elevational view of a precursor of a fiber reinforced foam structure of the present invention; and

FIG. 2 is a schematical representation of the process for making the precursor.

### DETAILED DESCRIPTION AND PREFERRED EMBODIMENTS OF THE INVENTION

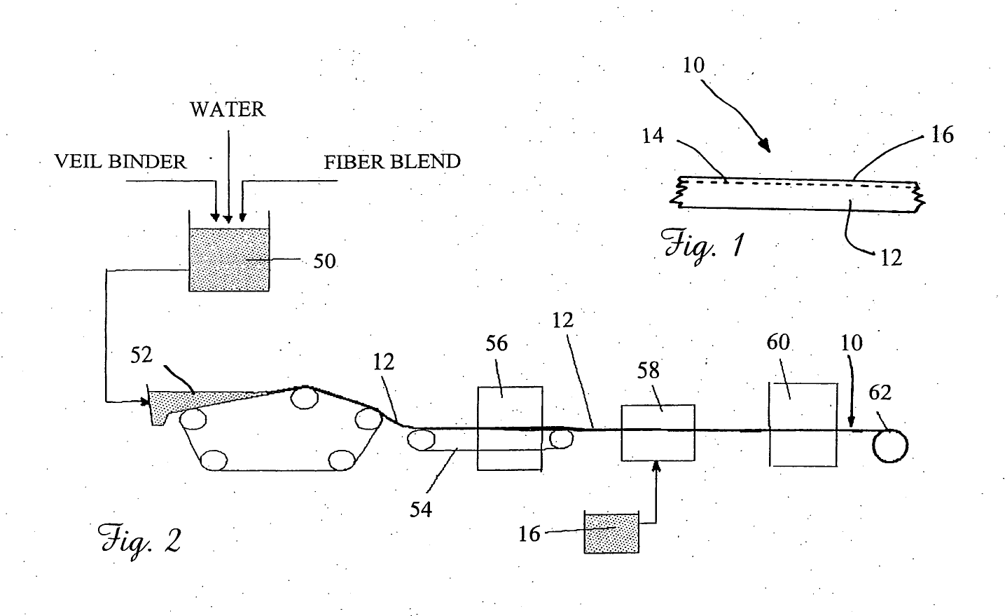

As illustrated in FIG. 1, the present invention relates to a precursor 10 of a fiber reinforced foam structure. The precursor 10 comprises a nonwoven fibrous base veil 12 that is impregnated on at least one face 14 with an expandable binder formulation 16 including expandable microspheres and an emulation or solution binder.

As used herein, the term “base veil” refers to a web of intermingled, randomly oriented reinforcing fibers made according to a wet-laid process. The base veil of the present invention may also include “sheets” or “mats” made in accordance with the wet-laid process.

“Impregnating” or “impregnated” as used herein, refers to a means of integrating an expandable binder into the fibrous veil. The method of impregnating may be conducted by any method suitable for integrating or incorporating the expandable binder into the fibrous veil. In accordance with the present invention, the expandable binder is impregnated into the base veil during a secondary impregnation step. In particular, the expandable binder is preferably impregnated after formation in a flooded nip section, which occurs after the veil passes through a first dryer.

The “microspheres” of the present invention are particles of thermoplastic resin material, which may have incorporated therein a chemical or physical blowing agent (e.g. isobutane, isopentane), and which are expanded upon heating. The microspheres of the present invention have an expanded diameter of between about 40 and about 150 microns.

The base veil 12 includes between about 50 and about 75 weight percent reinforcement fibers and between about 50 and about 25 weight percent veil binder. Further the base veil 12 has a weight per unit area of between about 35 and about 400 g/m². The precursor 10 has a weight per unit area of between about 100 to about 200 g/m².

The reinforcement fibers of the base veil 12 are typically selected from a group consisting of fiberglass fibers, aramid fibers, carbon fibers, polyester fibers, polyamide fibers, ceramic fibers and mixtures thereof. It should be appreciated, however, that any organic or inorganic fibers known to be useful as reinforcement fibers may be utilized. Where fiberglass fibers are used, they may be of substantially any type known in the art including but not limited to E-glass, A-glass, C-glass, D-glass, S-glass, S2-glass and R-glass. Typically the reinforcement fibers are chopped and have a length of between about 6.0 and about 38.0 mm and a diameter of between about 6.5 and about 23.0 microns. The chopped fibers may be individual fibers, filaments or strands. The reinforcement fibers can consist of a mix of coarse and fine fibers.

The veil binder utilized in the base veil 12 is typically a thermoplastic binder. The veil binder may be selected from a group consisting of but not limited to polyolefin, polyester, polyethylene, polypropylene, polyethylene terephthalate, polyamide, copolyester and mixtures thereof. The veil binder typically comprises fibers having a length of between about 0.5 to about 15.0 mm and a denier of between about 1 to about 5. The veil binder fibers may take the form of bicomponent fibers if desired. Alternatively or in addition, the veil binder may comprise a powder having particles of between 10 to about 50 microns.

The expandable binder formulation 16 typically comprises expandable microspheres and an emulsion or solution binder. That emulsion or solution binder may be selected from a group of materials including but not limited to ethylene vinyl acetate, polyvinyl alcohol, polyurethane, styrene butadiene rubber, cellulose, starch, urea formaldehyde, melamine formaldehyde, acrylic, fluorocarbon and mixtures thereof. The thermoplastic resin of the microspheres may be selected from a group of materials including but not limited to acrylonitrile, polyvinyl chloride, polyvinylidine chloride and mixtures thereof. Microsphere products useful in the present invention include Expancel 054WU, Expancel 461WU and Expancel 930DU. The microspheres have an expanded diameter of between about 40 and about 150 microns.

The expandable binder formulation 16 may further include useful fillers such as pigments, antibacterial agents and flame retardants. Useful flame retardants include but are not limited to aluminum trihydrate, magnesium hydroxide, calcium hydroxide, calcium carbonate and mixtures thereof.

The process of manufacturing the precursor 10 of the present invention is illustrated in FIG. 2. In the illustrated wet-lay process, the fiber blend, veil binder and water are agitated in a mixing tank 50 to provide an aqueous fiber slurry. The fiber blend is used as filaments. Additional elements to make up the aqueous slurry may be added as is known in the art. For example, antistatic agents, hydrophobic or repellency agents, coupling agents, pigments, surfactants, anti-foams, colorants and fillers may be provided along with the veil binder into the slurry.

As illustrated in FIG. 2 the aqueous fiber slurry is transferred from the mixing tank 50 onto a suitable forming apparatus 52. The forming apparatus 52 may, for example, take the form of a moving screen or forming wire on an inclined wire forming machine, wire cylinders, Foudrinier machines, Stevens Former, Roto Former, Inver Former or Venti Former machines. Preferably, the formation of the base veil 12 is on an inclined wire forming machine. The fibers and the additional slurry elements in the aqueous fiber slurry enmesh themselves into a freshly prepared base veil 12 on the forming apparatus 52 while excess water is separated therefrom. The dewatering step may be conducted by any known method such as by draining, vacuum, etc. The water content of the veil after dewatering and vacuum is preferably in the range of about 40 to about 70%.

After the base veil 12 is formed, the veil is transferred to a transport belt 54. The belt 54 carries the base veil 12 into a means 56 for substantially removing the water. The removal of water may be conducted by known web drying methods, including the use of a rotary/through air dryer or oven, a heated drum dryer, an infrared heating source, hot air blowers, microwave emitting source and the like. At least one method of drying is necessary for removing the water but a plurality of these methods may be used in combination to remove the water and dry the wet laid fibrous veil 12. The temperature of the dryer may range from about 80 degrees C. at the start until about 200 degrees C. at the end of the first drying process. The air speed may be in the range of about 0.5 to 1 m/s. During drying the veil binder is bound to the reinforcing fibers in order to prebond the base veil 12.

A face 14 of the base veil 12 is then impregnated with the binder formulation 16. Any method suitable for impregnating the face 14 of the base veil 12 may be used. For example, suitable methods include using a size press 58, such as a Foulard applicator, dipping roll, flooded nip, and the like. While other additional agents or coatings may be applied, preferably only the binder formulation 16 is contacted with the base veil 12. Following the impregnation of the face 14 of the base veil 12 with the binder formulation 16, is the drying and consolidating of the impregnated fibrous veil 10. Thus the now impregnated veil or precursor 10 is dried in a second dryer 60 which is preferably an airfloat oven. Typically drying temperatures do not exceed about 120 degrees C. so as to avoid expanding the microspheres in the formulation 16. The resulting precursor 10 is then collected on a winder 62.

The precursor 10 of the present invention may be used for a number of applications including but not limited to a number of vehicular applications such as for a head liner, hood liner, insulation part or underbody protection part. The lightweight, acoustic properties, strength, dimensional stability and stiffness make the precursor 10 of the present invention particularly useful for such applications.

More specifically, a desired length of precursor 10 is unrolled and loaded into a mold. The precursor 10 is then molded into a desired shape at a temperature above 120 degrees C. sufficient to activate the microspheres and cause expansion. The precursor 10 expands filling the mold with a fiber reinforced foam structure. The resulting part is then quenched or cooled to prevent further expansion before being released from the mold.

The foregoing description of the preferred embodiments of the invention has been presented for purposes of illustration and description. It is not intended to be exhaustive or to limit the invention to the precise form disclosed. Obvious modifications or variations are possible in light of the above teachings. For example, instead of preparing a precursor 10 that is rolled onto a winder 62, it is possible to directly mold a part from the impregnated base veil 12. More specifically, following impregnation a veil of desired length would be placed directly into a mold and heated to a sufficient temperature to activate the microspheres and cause expansion so that the material fills the mold. Following quenching and cooling below the expansion temperature the mold is opened to release the finished part.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A precursor of a fiber reinforced foam structure, comprising:
a base veil including between about 50 and about 75 weight percent reinforcement fibers and between about 50 and about 25 weight percent veil binder, said base veil having a weight per unit area of between about 35 and about 400 g/m²; and
said base veil being impregnated with an expandable binder in an amount of between about 20 to about 200 g/m².

2. The precursor of claim 1, wherein said reinforcement fibers are selected from a group consisting of fiberglass fibers, aramid fibers, carbon fibers, polyester fibers, polyamide fibers, ceramic fibers and mixtures thereof.

3. The precursor of claim 2, wherein said veil binder is a thermoplastic binder.

4. The precursor of claim 3, wherein said veil binder is selected from a group consisting of polyolefin, polyester, polyethylene, polypropylene, polyethylene terephthalate, polyamide, copolyester and mixtures thereof.

5. The precursor of claim 4, wherein said veil binder comprises fibers having a length of between about 0.5 to about 15.0 mm and a denier of between about 1 to about 5.

6. The precursor of claim 5, wherein said veil binder fibers are bicomponent fibers.

7. The precursor of claim 4, wherein said veil binder comprises a powder having particles of between about 10 to about 50 microns.

8. The precursor of claim 4, wherein said reinforcement fibers are chopped and have a length of between about 6.0 and about 38.0 mm and a diameter of between about 6.5 and about 23.0 microns or consist of a mix of fine and coarse fibers.

9. The precursor of claim 8, wherein said expandable binder comprises expandable microspheres and an emulsion or solution binder.

10. The precursor of claim 9, wherein said emulsion or solution binder is selected from a group consisting of ethylene vinyl acetate, polyvinyl alcohol, polyurethane, styrene butadiene rubber, cellulose, starch, urea formaldehyde, melamine formaldehyde, acrylic, fluorocarbon, and mixtures thereof.

11. The precursor of claim 10, wherein said expandable microspheres comprise a thermoplastic resin material incorporating a blowing agent.

12. The precursor of claim 9, wherein said precursor has a weight per unit area of between about 100 to about 200 g/m².

13. The precursor of claim 1, wherein said veil binder is a thermoplastic binder.

14. The precursor of claim 1, wherein said veil binder is selected from a group consisting of polyolefin, polyester, polyethylene, polypropylene, polyethylene terephthalate, polyamide, copolyester and mixtures thereof.

15. The precursor of claim 14, wherein said veil binder comprises fibers having a length of between about 0.5 to about 15 mm and a denier of between about 1 to about 5.

16. The precursor of claim 15, wherein said veil binder fibers are bicomponent fibers.

17. The precursor of claim 14, wherein said veil binder comprises a powder having particles of between about 10 to about 50 microns.

18. The precursor of claim 14, wherein said expandable binder comprises expandable microspheres and an emulsion or solution binder.

19. The precursor of claim 1, wherein said precursor has a weight per unit area of between about 100 to about 200 g/m².

20. A method of preparing a precursor of a fiber reinforced foam structure, comprising:
forming a base veil including between about 50 and about 75 weight percent reinforcement fibers and about 50 and about 25 weight percent veil binder, said base veil having a weight per unit area of between about 35 and about 400 g/m; and
impregnating said base veil with an expandable binder in an amount of between about 20 to about 200 g/m².

21. A fiber reinforced foam structure made from the precursor of claim 1.

22. A method of preparing a fiber reinforced foam structure, comprising:
forming a base veil including between about 50 and about 75 weight percent reinforcement fibers and about 50 and about 25 weight percent veil binder, said base veil having a weight per unit area of between about 35 and about 400 g/m²;
impregnating said base veil with an expandable binder in an amount of between about 20 to about 200 g/m²; and
molding said impregnated base veil at a temperature sufficient to cause said expandable binder to expand and form said fiber reinforced foam structure.
